(19) United States
(12) Patent Application Publication
(10) Pub. No.: US 2022/0342925 A1
(43) Pub. Date: Oct. 27, 2022

(54) MATERIAL PRESENTATION METHOD, ELECTRONIC DEVICE, AND STORAGE MEDIUM

(71) Applicant: BEIJING BYTEDANCE NETWORK TECHNOLOGY CO., LTD., Beijing (CN)

(72) Inventor: Shuai LIU, Beijing (CN)

(21) Appl. No.: 17/858,382

(22) Filed: Jul. 6, 2022

Related U.S. Application Data
(63) Continuation of application No. PCT/CN2020/141381, filed on Dec. 30, 2020.

(30) Foreign Application Priority Data
Jan. 6, 2020 (CN) 202010011306.2

(51) Int. Cl. G06F 16/438; G06F 16/45; G06F 16/44

(52) U.S. Cl. CPC G06F 16/4393; G06F 16/45; G06F 16/447

(57) ABSTRACT

Provided are a material presentation method an electronic device and a storage medium. The material presentation method includes steps described below. A data update request is received from a client. In response to the data update request carrying a splash presentation identifier of a splash presentation material, a news feed presentation material corresponding to the splash presentation identifier is acquired. The news feed presentation material is inserted into a preset presentation position of a news feed list page.

### CROSS REFERENCE TO RELATED APPLICATION

This is a continuation of International Patent Application No. PCT/CN2020/141381 and filed on Dec. 30, 2020, which claims priority to Chinese Patent Application No. 202010011306.2 filed with the China National Intellectual Property Administration (CNIPA) on Jan. 6, 2020, the disclosures of which are incorporated herein by reference in their entireties.

### TECHNICAL FIELD

The present disclosure relates to the field of computer technologies, for example, a material presentation method and apparatus, an electronic device and a storage medium.

### BACKGROUND

The emergence of smart phones and the wireless network not only solves the problem of poor communication between two or more parties, but also provides more choices for users in learning, working and entertainment. For example, a wide variety of clients are installed on mobile phones for watching videos, etc. The developers of the clients are also continuously optimizing the multiple presentation functions of the clients to meet users' personalized needs.

However, the splash presentation material and the news feed presentation material presented by the clients are independent from each other in terms of not only the content but also the presentation manner, and thus the linkage cannot be achieved, leading to unsatisfactory presentation effects of the presentation material and affecting the user experience.

### SUMMARY

The present disclosure provides a material presentation method and apparatus, an electronic device and a storage medium, so as to solve the problem that the material presentation effect is not ideal due to the mutual independence and random configuration of the news feed presentation material and the splash presentation material, and thus the presentation effect of the presentation material and the user experience are improved.

A material presentation method is provided and includes steps described below.

A data update request is received from a client.

In a case where the data update request carries a splash presentation identifier of a splash presentation material, a news feed presentation material corresponding to the splash presentation identifier is acquired.

The news feed presentation material is inserted into a preset presentation position of a news feed list page.

A material presentation method is further provided and includes steps described below.

A to-be-presented splash presentation material is received.

In a case where the received to-be-presented splash presentation material carries a splash presentation identifier, a data update request carrying the splash presentation identifier is sent to a news feed server, so as to acquire a news feed presentation material corresponding to the splash presentation identifier from the news feed server.

A news feed presentation material carrying a preset presentation position of a news feed list page and issued by the news feed server is received.

A material presentation apparatus is further provided and includes a data update request reception module, a news feed presentation material acquisition module and a presentation module.

The data update request reception module is configured to receive a data update request from a client.

The news feed presentation material acquisition module is configured to in a case where the data update request carries a splash presentation identifier of a splash presentation material, acquire a news feed presentation material corresponding to the splash presentation identifier.

The presentation module is configured to insert the news feed presentation material into a preset presentation position of a news feed list page.

A material presentation apparatus is further provided and includes a splash presentation material reception module, a data update request sending module and a news feed presentation material reception module.

The splash presentation material reception module is configured to receive a to-be-presented splash presentation material.

The data update request sending module is configured to in a case where the received to-be-presented splash presentation material carries a splash presentation identifier, send a data update request carrying the splash presentation identifier to a news feed server, so as to acquire a news feed presentation material corresponding to the splash presentation identifier from the news feed server.

The news feed presentation material reception module is configured to receive a news feed presentation material carrying a preset presentation position of a news feed list page and issued by the news feed server, and present the news feed presentation material at the preset presentation position.

An electronic device is further provided. The electronic device includes one or more processors and a storage apparatus configured to store one or more programs.

The one or more programs, when executed by the one or more processors, cause the one or more processors to implement the preceding material presentation method.

A storage medium including computer-executable instructions is further provided. The computer-executable instructions, when executed by a computer processor, are configured to execute the preceding material presentation method.

### BRIEF DESCRIPTION OF DRAWINGS

FIG. 1 is a flowchart of a material presentation method according to embodiment one of the present disclosure;

FIG. 2 is a flowchart of a material presentation method according to embodiment two of the present disclosure;

FIG. 3 is a flowchart of a material presentation method according to embodiment three of the present disclosure;

FIG. 4A is a flowchart of a material presentation method according to embodiment four of the present disclosure;

FIG. 4B is an interaction flowchart corresponding to a material presentation method according to embodiment four of the present disclosure;

FIG. 5 is a structural diagram of a material presentation apparatus according to embodiment five of the present disclosure;

FIG. 6 is a structural diagram of a material presentation apparatus according to embodiment six of the present disclosure; and

FIG. 7 is a structural diagram of an electronic device according to embodiment seven of the present disclosure.

### DETAILED DESCRIPTION

Embodiments of the present disclosure will be described below with reference to the drawings. Although the drawings show some embodiments of the present disclosure, the present disclosure may be implemented in various forms.

The various steps recited in method embodiments of the present disclosure may be performed in a different order and/or in parallel. In addition, the method embodiments may include additional steps and/or omit execution of illustrated steps. The scope of the present disclosure is not limited in this respect.

As used herein, the term “include” and variations thereof are intended to be inclusive, that is, “including, but not limited to”. The term “based on” is “at least partially based on”. The term “one embodiment” means “at least one embodiment”; the term “another embodiment” means “at least one another embodiment”; and the term “some embodiments” means “at least some embodiments”. Related definitions of other terms are given in the description hereinafter. Concepts such as “first” and “second” in the present disclosure are merely intended to distinguish one from another apparatus, module or unit and are not intended to limit the order or interrelationship of the functions performed by the apparatus, module or unit.

“One” and “a plurality” mentioned in the present disclosure are illustrative, are not intended to limit the present disclosure, and should be understood as “one or more” unless clearly expressed in the context.

### Embodiment One

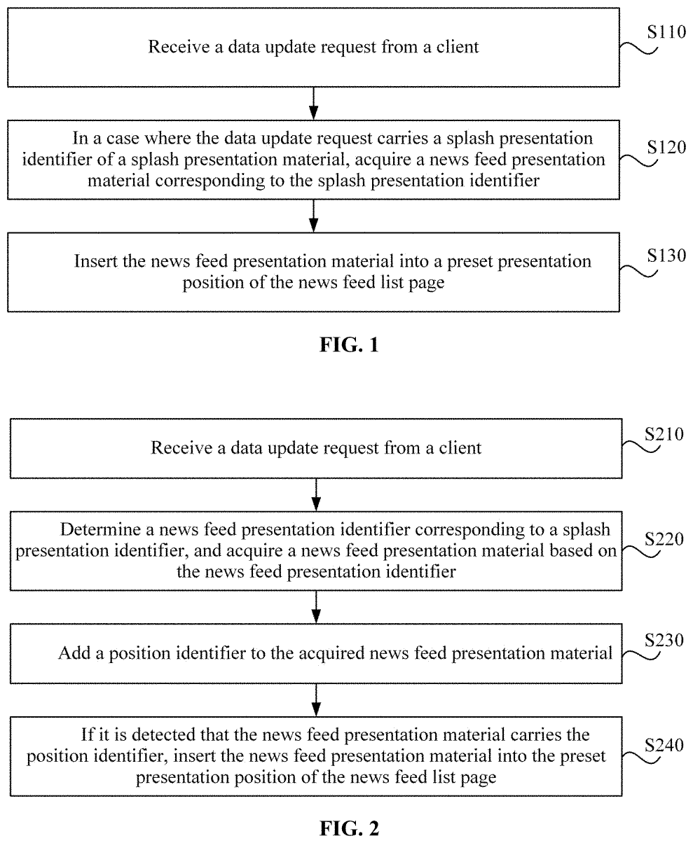

FIG. 1 is a flowchart of a material presentation method according to embodiment one of the present disclosure. The embodiment of the present disclosure is applicable to the case of presenting a news feed presentation material corresponding to a splash presentation material at a preset position after the playing of the splash presentation material is completed. The method may be executed by a material presentation apparatus which may be implemented in the form of software and/or hardware. Optionally, the material presentation apparatus may be implemented by an electronic device which may be a server, a mobile terminal, a personal computer (PC) terminal, etc.

As shown in FIG. 1, the method in this embodiment includes steps described below.

In S110, a data update request is received from a client.

At least one client may be installed on the mobile terminal. When a user performs the operation of triggering an application software icon to open the client, that is, starting an application program, the server corresponding to the client may receive request information corresponding to starting the application program, and the request information received by the server at this time may be taken as the data update request. Alternatively, if it is detected that the application software is running in the background for more than a preset period of time, when the user triggers the application program, a data update request is triggered, and the server may receive the data update request.

When the user triggers the client installed on the mobile terminal, the server corresponding to the client may receive the data update request from the client.

In S120, in a case where the data update request carries a splash presentation identifier of a splash presentation material, a news feed presentation material corresponding to the splash presentation identifier is acquired.

Generally, when the client starts to run, a splash presentation material is presented, and after the presentation of the splash presentation material is completed, the splash presentation material enters a news feed list page. In the material presentation method, news feed presentation materials presented by the news feed list page are all randomly configured and have no association with the splash presentation material, that is, the linkage between the splash presentation material and the news feed presentation materials cannot be achieved, and in addition, there are a variety of presentation materials and the presentation duration of the presentation material is very limited, which makes the material presentation effect unsatisfactory and affects the user experience.

When the user triggers the application program, the process of presenting an image on the display screen before the home page of the application program is entered is referred to as the splash presentation, and the image displayed on the display screen at this time is taken as a splash presentation image. The image may be an animation, a video and/or a picture. For example, when the software of a short video application is opened, brand information or promotional information of a good delivered on the application software may be presented before a short video recommendation list page is entered. The process of presenting the image after the application program is triggered and before the home page of the program is entered is referred to as the splash presentation. The presented brand information or the promotional information of a good is understood as the splash presentation material, that is, the content of the splash presentation image is referred to as the splash presentation material. Since there are more than one splash presentation materials, the splash presentation materials and the news feed presentation materials may be marked to determine which splash presentation material the client acquires and what news feed presentation material the server needs to acquire. The splash presentation identifier may be understood as an identifier corresponding to the splash presentation material. The news feed presentation material may be understood as promotional information, food information and the like that may be presented in news feeds (such as the home page of the news feeds).

To speed up the response, at least one splash presentation material may be preloaded and stored in the client. To-be-presented splash presentation materials may be the same or different for different users. Which splash presentation material to present may be determined by a material presentation strategy preset in the server. Optionally, the material presentation strategy may be determined according to a material pushing plan or the like.

When the data update request received by the server carries a splash presentation identifier, that is, when the current client supports the splash presentation, the news feed presentation material associated or having a corresponding relationship with the splash presentation identifier may be searched for according to the splash presentation identifier from a cache area storing the news feed presentation materials.

When the user triggers the operation of starting the application program, a software development tool set in the client may determine whether the version corresponding to the application program supports the splash presentation. If the version corresponding to the application program supports the splash presentation, the client acquires a splash presentation material, acquires an identifier corresponding to the splash presentation material, and sends a data update request carrying the splash presentation identifier to the server. If the version corresponding to the application program does not support the splash presentation, the server may send a predetermined news feed presentation material to the client according to a preset presentation strategy in the background, so as to present the predetermined news feed presentation material in a news feed presentation page of the client.

In S130, the news feed presentation material is inserted into a preset presentation position of the news feed list page.

The news feed list page may include a list page of short video recommendations, that is, the news feed list page includes at least one short video list thereon.

When the news feed presentation material corresponding to the splash presentation identifier is acquired according to the splash presentation identifier, the news feed presentation material may be forcibly inserted into the preset presentation position of the news feed list page. Optionally, the preset presentation position may include a top position or a middle position of the page. The first position in the news feed list page is taken as the presentation position at the top of the news feed list page. Exemplarily, the middle position of the news page may be determined according to the number of presentation positions in the current display screen, and the middle position may be understood as positions excluding the positions at the top and bottom of the news feed list page. For example, if the current display screen has five presentation positions, the presentation may be performed at the third presentation position, the second presentation position or the fourth presentation position. The preset presentation position may be a bottom position. The preset presentation position may be set according to actual requirements, which is not limited here.

Exemplarily, the news feed presentation material is forcibly inserted into the top position of the news feed list page, that is, the first position of the news feed list page. In this way, the order of the presentation, which is generally performed from top to bottom, of presentation materials at multiple presentation positions of the news feed list page is fully taken into consideration, so that the linkage between the splash presentation material and the news feed presentation material is established. When the playing of the splash presentation material is completed, the news feed presentation material is immediately presented on the top of the news feed list page, so that the delivery effect of the presentation material is improved.

Optionally, the splash presentation material has the same presentation content as the news feed presentation material. If the splash presentation material has the same presentation content as the news feed presentation material, when the news feed presentation material is then presented after the presentation of the splash presentation material is completed, the linkage in the content between the splash presentation material and the news feed presentation material is established, so that the presentation duration of the material is increased, and the material presentation effect is improved.

Optionally, the splash presentation material is stored at a different position from the news feed presentation material. The splash presentation material needs to be immediately presented when the client is opened. If the splash presentation material is stored at the same position as the news feed presentation material, or the same presentation material is used, acquiring, through news feed pushing, the splash presentation material that needs to be immediately presented may be affected by the network quality, leading to non-timely update of the splash presentation material. Therefore, the splash presentation material and the news feed presentation material may be stored at different positions. Since the news feed presentation material needs to be presented only after the client presents the splash presentation material and then the news feed list page is entered, and the presentation content of the news feed presentation material is generally determined by the splash presentation material, the news feed presentation material may be acquired in real time through news feed pushing in response to a presentation request of the splash presentation material.

According to the technical solution of the embodiment, a data update request is received from a client, and in a case where the data update request carries a splash presentation identifier of a splash presentation material, a news feed presentation material corresponding to the splash presentation identifier is acquired, that is, the news feed presentation material is determined through the splash presentation identifier, so as to achieve the linkage presentation of the splash presentation material and the news feed presentation material. In addition, the news feed presentation material is not randomly configured with a presentation position in a news feed list page, but inserted into a preset presentation position at the top of the news feed list page. Since the material presentation resources generally have certain limitations, that is, are limited resources, the presentation resource occupied by the splash presentation material is associated with the presentation resource occupied by the news feed presentation material, solving the problems that the presentation duration of the material is short, the presentation effect is not ideal, and the user experience is affected due to the unachievable linkage resulting from the mutual independence and random configuration of the splash presentation material and the news feed presentation material. After the presentation of the splash presentation material is completed, the news feed presentation material corresponding to the splash presentation material is forcibly inserted into the preset presentation position of the news feed list page for presentation, so that the material presentation effect and the user experience are improved.

### Embodiment Two

FIG. 2 is a flowchart of a material presentation method according to embodiment two of the present disclosure. Based on the preceding technical solution, optionally, the step in which the news feed presentation material is inserted into the preset presentation position of the news feed list page includes steps described below. A position identifier is added to the acquired news feed presentation material. If it is detected that the news feed presentation material carries the position identifier, the news feed presentation material is inserted into the preset presentation position of the news feed list page.

As shown in FIG. 2, the method includes steps described below.

In S210, a data update request is received from a client.

Exemplarily, an application program is A, when a user triggers the application program A, a server corresponding to the application program A may receive a data update request from the client.

In S220, a news feed presentation identifier corresponding to a splash presentation identifier is determined, and a news feed presentation material is acquired based on the news feed presentation identifier.

To improve the presentation effect of the presentation material, a splash presentation material may have the same content displayed on a display interface as the news feed presentation material. However, since the size of the image of the splash presentation is different from the size of the news feed presentation material presented on a news feed page, and the splash presentation image is preloaded and stored, the splash presentation material may be stored at a different position and may have a different identifier from the news feed presentation material.

To quickly acquire the news feed presentation material having the same content as the splash presentation material, a corresponding relationship between the splash presentation identifier and the news feed presentation identifier may be preestablished. Optionally, the news feed presentation identifier corresponding to the splash presentation identifier is determined according to the preestablished corresponding relationship between the splash presentation identifier and the news feed presentation identifier.

The image of the splash presentation material may have the same content as the image presented by the news feed presentation material. The splash presentation material is applied in a different scene from the news feed presentation material, so that the splash presentation material may have different data and a different identifier from the news feed presentation material. To acquire the news feed presentation material when the splash presentation material is acquired, the corresponding relationship between the splash presentation identifier and the news feed presentation identifier needs to be preestablished.

Exemplarily, it is assumed that a storage space for storing splash presentation materials is A and a storage space for storing news feed presentation materials is B, a presentation material C and a presentation material D who have the same presentation content are respectively stored in the storage space A and the storage space B, and a corresponding relationship between the presentation material C and the presentation material D is established, that is, once it is detected that the splash presentation material is C, the corresponding news feed presentation material is D.

Presentation materials having the same presentation content are taken as the same group of presentation materials. A splash presentation material and a news feed presentation material in the same group of presentation materials are configured with the same or corresponding tags and are respectively stored, and then the corresponding relationship between the presentation materials is determined according to the tags of the presentation materials. At this time, acquiring the news feed presentation material may be that the news feed presentation identifier corresponding to the splash presentation identifier is searched for according to the splash presentation identifier from a corresponding relationship table, and the news feed presentation material corresponding to the news feed presentation identifier is acquired.

Other ways may also be used for establishing the corresponding relationship between the splash presentation material and the news feed presentation material. In the practical application process, the user may establish the corresponding relationship between the splash presentation material and the news feed presentation material according to actual situations. The corresponding relationship is established, so that the news feed presentation material corresponding to the splash presentation material can be quickly determined and presented on a news feed list page, thus the linkage between the splash presentation material and the news feed presentation material is established, and the presentation effect of the presentation material and the user experience are improved.

In S230, a position identifier is added to the acquired news feed presentation material. When the news feed presentation material corresponding to the splash presentation identifier is acquired according to the splash presentation identifier from a storage area or a cache area storing multiple news feed presentation materials, a tag, that is, a position identifier, for presenting the news feed presentation material at a preset presentation position of the news feed list page may be added to the news feed presentation material. The position identifier is added to the news feed presentation material, so that when the presentation of the splash presentation material is ended, the user, if interested in the product introduced in the presentation material, can view the presentation material at the preset presentation position of the news feed list page, avoiding the problem that the user cannot accurately find the splash presentation material after the presentation of the splash presentation material is ended.

In S240, if it is detected that the news feed presentation material carries the position identifier, the news feed presentation material is inserted into the preset presentation position of the news feed list page.

In the embodiment, the server executes different operations, which may be implemented based on a function module disposed in the server. Optionally, a stream module may be disposed in the server. When detecting that the news feed presentation material carries the position identifier, the stream module may process the news feed presentation material carrying the position identifier, so as to insert the content of the news feed presentation material into the preset presentation position of the news feed list page.

According to the technical solution of the embodiment of the present disclosure, a data update request is received from a client, if the data update request carries a splash presentation identifier of a splash presentation material, a news feed presentation material corresponding to the splash presentation identifier is acquired, and the news feed presentation material is inserted into a preset presentation position of a news feed list page. In this way, the problems are solved that the presentation effect of the presentation material is unsatisfactory and the user experience is affected due to the random configuration of and no linkage between the splash presentation material presented when the client starts to run and the news feed presentation material presented when the news feed list page is entered after the presentation of the splash presentation material is completed. Therefore, after the presentation of the splash presentation material is completed, the presentation material corresponding to the splash presentation material is forcibly inserted into the preset presentation position of the news feed list page, the linkage between the splash presentation material and the news feed presentation material is established, the duration the user watching the presentation material is increased, and the presentation effect of the presentation material and the user experience are improved.

### Embodiment Three

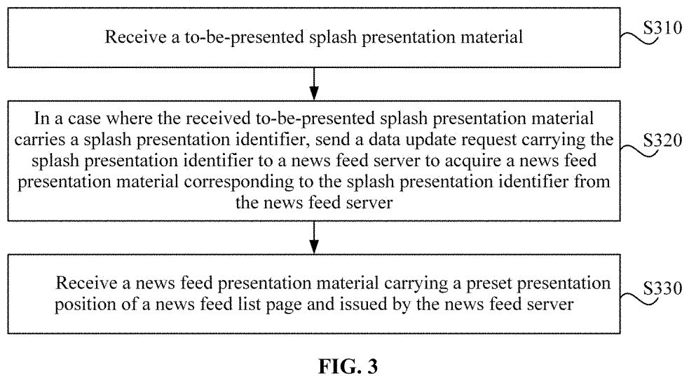

FIG. 3 is a flowchart of a material presentation method according to embodiment three of the present disclosure. The embodiment of the present disclosure is applicable to the case where a news feed presentation material is presented at a preset position. The method may be executed by a material presentation apparatus which may be implemented in the form of software and/or hardware. Optionally, the material presentation apparatus may be implemented by an electronic device which may be a server, a mobile terminal, a PC terminal, etc.

As shown in FIG. 3, the material presentation method in this embodiment includes steps described below.

In S310, a to-be-presented splash presentation material is received.

In S320, in a case where the received to-be-presented splash presentation material carries a splash presentation identifier, a data update request carrying the splash presentation identifier is sent to a news feed server, so as to acquire a news feed presentation material corresponding to the splash presentation identifier from the news feed server.

In S330, a news feed presentation material carrying a preset presentation position of a news feed list page and issued by the news feed server is received.

According to the technical solution of the embodiment of the present disclosure, a to-be-presented splash presentation material is received, and in a case where the received to-be-presented splash presentation material carries a splash presentation identifier, a data update request carrying the splash presentation identifier is sent to a news feed server, so as to acquire a news feed presentation material corresponding to the splash presentation identifier, that is, the news feed presentation material is determined through the splash presentation identifier, so that the linkage presentation of the splash presentation material and the news feed presentation material is achieved. Moreover, a news feed presentation material carrying a preset presentation position of a news feed list page and issued by the news feed server is received, and the news feed presentation material is presented at the preset presentation position, that is, the news feed presentation material is not randomly configured with a presentation position in the news feed list page, but inserted into the preset presentation position of the news feed list page. Since the material presentation resources generally have certain limitations, that is, are limited resources, the presentation resource occupied by the splash presentation material is associated with the presentation resource occupied by the news feed presentation material, solving the problems that the presentation duration of the material is short, and the presentation effect is not ideal due to the unachievable linkage resulting from the mutual independence and random configuration of the splash presentation material and the news feed presentation material. In this way, the material presentation effect and the user experience are improved.

### Embodiment Four

An embodiment of the present disclosure further provides a material presentation system. The material presentation system includes a news feed server. The news feed server may be configured to: receive a data update request from a client; in a case where the data update request carries a splash presentation identifier of a splash presentation material, acquire a news feed presentation material corresponding to the splash presentation identifier; and insert the news feed presentation material into a preset presentation position of a news feed list page.

Based on the preceding technical solution, the material presentation system includes a client. The client is configured to receive a to-be-presented splash presentation material; in a case where the received to-be-presented splash presentation material carries a splash presentation identifier, send a data update request carrying the splash presentation identifier to a news feed server, so as to acquire a news feed presentation material corresponding to the splash presentation identifier from the news feed server. The client receives a news feed presentation material issued by the news feed server and presents the splash presentation material. Further, after the splash presentation material is presented, the client presents the news feed presentation material.

Before the client receives the to-be-presented splash presentation material, the client may request a splash presentation material from a splash server and receive a splash presentation material issued by a preset cache area of the terminal installed with the client or issued by the splash server. The splash presentation material in the preset cache area is pre-issued by the splash server before the client requests the splash presentation material from the splash server. The news feed server and the splash server may be integrated in the same physical server.

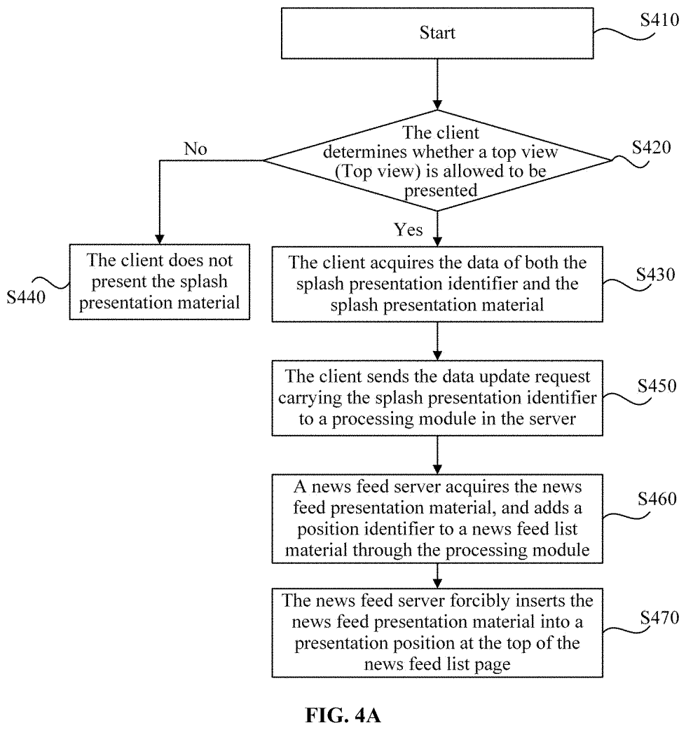

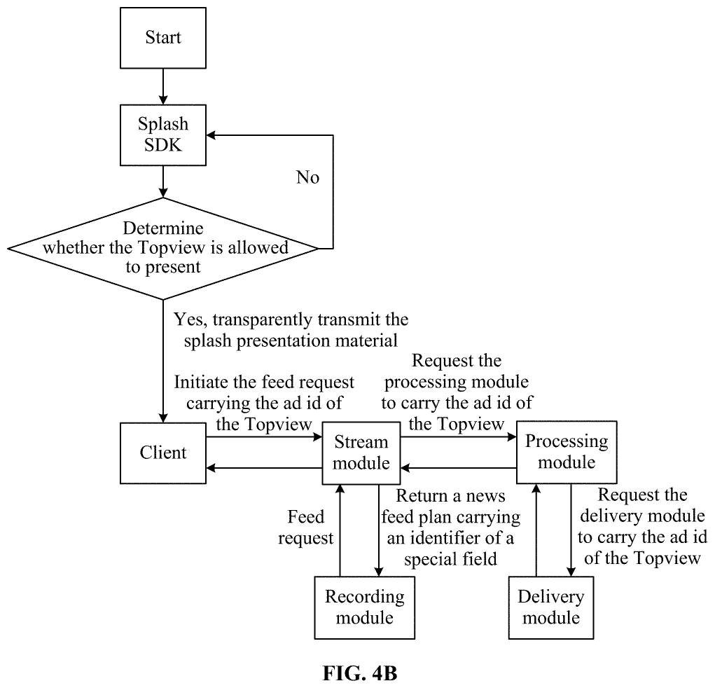

FIG. 4A is a flowchart of a material presentation method according to embodiment four of the present disclosure. As shown in FIG. 4A, the splash presentation material issued by the splash server being landscape-mode video data is taken as an example. The material presentation method provided in the embodiment may include steps described below.

In S410, starting is performed.

The starting may be understood as that a client triggers an application program.

In S420, the client determines whether a top view (Topview) is allowed to be presented. If the Topview is allowed to be presented, S430 is executed; if the Topview is not allowed to be presented, S440 is executed.

Determining whether the Topview is allowed to be presented is performed through a splash software development kit (SDK) installed on the client. In the embodiment of the present disclosure, the Topview may be understood as a splash presentation material, for example, a splash presentation material having a preset animation effect.

When it is detected that the starting of the application program is triggered, the SDK needs to determine whether the current presentation environment allows the splash presentation of the splash presentation material Topview, that is, whether the client supports the splash presentation. If the current presentation environment allows the splash presentation of the Topview, the client may send a data update request carrying a splash presentation identifier to a server. If the current display environment does not allow the splash presentation of the Topview, optionally, the current version of the client is relatively low and thus cannot support the splash display, and then the splash presentation of the splash presentation material Topview is not displayed. A backup splash image may be displayed.

That is, before the server receives the data update request (a feed request), the client needs to first complete interaction with the splash software development kit (SDK), through which whether to present the splash presentation material Topview is determined.

If the SDK determines that the client supports the splash presentation of the Topview, the SDK sends the data of both the splash presentation identifier and the splash presentation material to the client. If the client does not support the splash presentation of the Topview, the presentation is performed according to a presentation strategy, and the splash presentation material is not presented.

In S430, the client acquires the data of both the splash presentation identifier and the splash presentation material.

If the client supports the splash presentation, the data of both the splash presentation identifier and the splash presentation material may be sent to the client, so that the splash presentation material is presented in the splash stage.

The splash presentation material may be acquired from a preset cache area or the server. The preset cache area may be set in the terminal installed with the client. The preset cache area may store at least one splash presentation material. To improve the efficiency of acquiring the splash presentation material, at least one splash presentation material may be preloaded from the server to the preset cache area, and then the client acquires the data of both the splash presentation identifier and the splash presentation material from the preset cache area. The cache material stored in the preset cache area may be periodically or aperiodically issued by the server, or may be actively requested from the server by the client. For example, it may be that when a user opens the client for the first time within a preset time period, the client sends an acquisition request for the splash material to the server. Then, the server loads at least one splash presentation material to the preset cache area. Through this logic of preloading, the splash presentation material is first stored in the preset cache area and is directly presented when needing to present, with a fast response speed and a small delay.

Exemplarily, the splash presentation material in the preset cache area is periodically issued by the server, for example, periodically issued by a splash server responsible for the splash presentation business. The splash server generally interacts with multiple terminals installed with the client, the periodical issuing of the splash presentation material is convenient for the server to integrally regulate and control the presentation information, such as the presentation manner, the presentation order and presentation frequency, of the splash presentation material, and also prevents the occurrence of situations such as lagging due to the network and other reasons when a client request is responded in real time, with a small response delay and the smoother presentation.

Exemplarily, from 8 am to 10 am each day, the splash presentation material delivered by the application software is determined to be A, and at that point in time, at least one splash presentation material may be preloaded for direct use during the splash display. For example, the user triggers the application program for the first time at 8:30 am, and the splash server transmits at least one splash presentation material to the preset cache area. Further, when it is determined that the client supports the splash presentation, if the splash presentation material A is to be presented currently, the splash presentation material A is acquired from the preset cache area for presentation on the client, and the splash presentation identifier corresponding to the splash presentation material A is determined.

In S440, the client does not present the splash presentation material.

If the client does not support the splash presentation, the client may not present the splash presentation material and present a backup presentation material, or a news feed page may be directly entered.

When it is detected that the client does not support the splash display but the splash presentation material exists, a news feed presentation material corresponding to the splash presentation identifier may be acquired according to the splash presentation material, and the news feed presentation material is displayed at a preset presentation position of a news feed list page.

In S450, the client sends the data update request carrying the splash presentation identifier to a processing module in the server.

The splash presentation identifier splash_ad_id is used for representing the splash presentation material when the client is during the splash stage. A delivery module (engine) may be understood as a module for storing the news feed presentation material. The processing module may process the user corresponding to the splash presentation material according to attribute information of the user, and selectively determine whether to present the splash presentation material and the news feed presentation material on the client corresponding to the user. To improve the presentation efficiency of the presentation material, the presentation material may also be delivered to all users who install the target software. The processing module may further search for the news feed presentation material, that is, a presentation material displayed on the news feed list page, corresponding to the splash presentation identifier splash_ad_id from a preestablished corresponding relationship table of splash presentation identifiers and news feed presentation identifiers.

The processing module may be denoted as sati. The client transparently transmits the data update request (the feed request) carrying the splash presentation identifier splash_ad_id to the sati in the news feed server through a stream module (stream) in the news feed server, and then the sati transparently transmits the feed request carrying the splash presentation identifier splash_ad_id to the engine, so that the engine acquires the news feed presentation material corresponding to the splash presentation identifier according to the splash presentation identifier and the preestablished relationship table corresponding to the splash presentation identifiers and the news feed presentation identifiers, and delivers the news feed presentation material to the sati.

In S460, a news feed server acquires the news feed presentation material, and adds a position identifier to a news feed presentation material through the processing module.

The sati may add the position identifier to the news feed presentation material.

When receiving the news feed presentation material corresponding to the splash presentation identifier and delivered by the engine, the sati may add the position identifier to the news feed presentation material.

In S470, the news feed server forcibly inserts the news feed presentation material into a presentation position at the top of the news feed list page.

The module for detecting whether the position identifier is carried may be the stream disposed in the server.

When detecting that the position identifier exists in the news feed presentation material, the stream may forcibly insert the news feed presentation material into the preset presentation position on the home page of the application program.

On this basis, when the presentation of the splash presentation material is completed, the home page of the program, that is, the news feed list page, may be returned to. The news feed presentation material is displayed at the preset presentation position of the news feed list page and may be automatically played. When the user scrolls the home page of the program and other information is not loaded, the news feed presentation material may be automatically played. If the news feed presentation material is scrolled out of a current display region of the screen, a material presentation time when the news feed presentation material is scrolled out of the screen is recorded. If the news feed presentation material is scrolled into the current display region of the screen, the material presentation time is acquired, and the news feed presentation material is continuously presented according to the material presentation time

When it is detected that the user scrolls the home page of the program to view the currently loaded page content but does not request to load a new page content, if the news feed presentation material is scrolled out of the current display region of the screen, the material presentation time when the news feed presentation material is scrolled out of the screen, that is, to which point in time the news feed presentation material is played, may be recorded through a recording module (go_mario, which is shown in FIG. 4B below) in the news feed server, so that when the user returns to the top of the home page, the news feed presentation material can be continuously played from the position where the playing is paused, improving the consistency of the news feed presentation material.

The manner described below may be used for determining that the news feed presentation material is scrolled out of the screen. If the presentation image of the news feed presentation material is completely scrolled out of the current display region of the screen, it is determined that the news feed presentation material is scrolled out of the screen; or, if the proportion of the presentation image of the news feed presentation material in the current display region of the screen is less than a preset proportion, it is determined that the news feed presentation material is scrolled out of the screen; etc.

FIG. 4B is an interaction flowchart corresponding to a material presentation method according to embodiment four of the present disclosure. As shown in FIG. 4B, when the user triggers the application program, the splash presentation material is normally issued, and the splash SDK interacts with the client. When the splash SDK determines that the client satisfies a presentation condition for the splash presentation of the splash presentation material Topview, the splash SDK transmits the data of both the splash presentation identifier splash_ad_id and the splash presentation material to the client. If the client does not satisfy the presentation condition of the presentation material Topview, the splash SDK determines a subsequent strategy, which may be, for example, displaying other materials. The client receives the splash presentation identifier splash_ad_id from the splash SDK, and sends the splash presentation identifier and the Topview identification to the stream module in the news feed server through the current data update request (the feed request). The stream module transparently transmits the splash presentation identifier and the Topview to the processing module (sati) in the news feed server, and the sati transparently transmits the splash presentation identifier and the Topview to the delivery module (engine). The engine acquires the news feed presentation material corresponding to the splash presentation identifier according to the preestablished corresponding relationship between the splash presentation material and the news feed presentation material, and issues the news feed presentation material to the sati, that is, the engine issues the news feed presentation material corresponding to the Topview in real time according to the splash_ad_id. The sati performs special processing on the presentation material Topview during queue filtering, and adds the position identifier for the presentation at the first position to the received news feed presentation material. When detecting the identifier for the display at the first position, the stream forcibly inserts the news feed presentation material into the first position of the news feed list page.

When requesting for increasing parameters, that is, when requesting the sati to search for the news feed presentation material according to the splash presentation identifier, the stream transparently transmits planning parameters of the Topview of the client to the engine. When the news feed presentation material is returned through the feed request, the stream checks a news feed presentation identifier awesome_ad field in request addition information feed_extra. If the awesome_ad field represents the news feed presentation material corresponding to the Topview, the news feed presentation material needs to be adjusted to a position needing for presentation, that is, the news feed presentation material is inserted into the preset presentation position of the news feed list page for presentation. The preset presentation position may be a top position. go_mario may record a current playing position of a video watched by the user on the news feed list page. When the home page is returned to, the playing position recorded in the go_mario may be read and sent to the client, so that the news feed presentation material can be continuously played from the pause position by the client. The playing position may be determined according to a playing duration or a playing time point.

According to the technical solution of the embodiment, a data update request is received from a client, if the data update request carries a splash presentation identifier of a splash presentation material, a news feed presentation material corresponding to the splash presentation identifier is acquired, and then the news feed presentation material is inserted into a preset presentation position of a news feed list page according to an added position identifier. In this way, the linkage between the splash presentation material and the news feed presentation material is established, the duration the user watching the presentation material is increased, the presentation effect of the presentation material is improved, and the user experience is improved.

### Embodiment Five

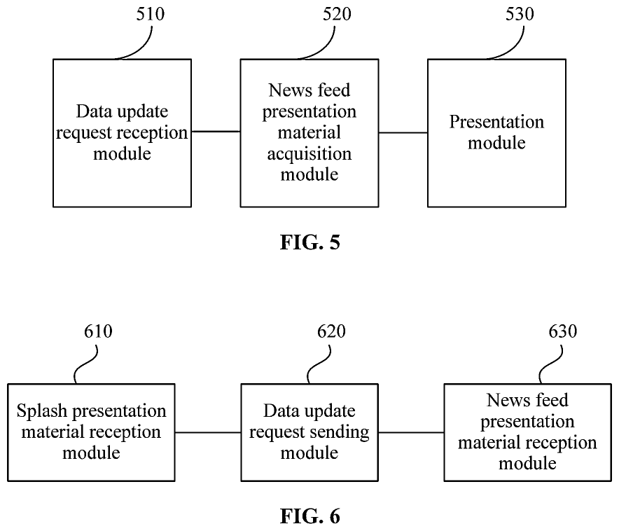

FIG. 5 is a structural diagram of a material presentation apparatus according to embodiment five of the present disclosure. As shown in FIG. 5, the apparatus includes a data update request reception module 510, a news feed presentation material acquisition module 520 and a presentation module 530.

The data update request reception module 510 is configured to receive a data update request from a client. The news feed presentation material acquisition module 520 is configured to in a case where the data update request carries a splash presentation identifier of a splash presentation material, acquire a news feed presentation material corresponding to the splash presentation identifier. The presentation module 530 is configured to insert the news feed presentation material into a preset presentation position of a news feed list page.

According to the technical solution of the embodiment of the present disclosure, a data update request is received from a client, and in a case where the data update request carries a splash presentation identifier of a splash presentation material, a news feed presentation material corresponding to the splash presentation identifier is acquired, that is, the news feed presentation material is determined through the splash presentation identifier, so as to achieve the linkage presentation of the splash presentation material and the news feed presentation material. In addition, the news feed presentation material is not randomly configured with a presentation position in a news feed list page, but inserted into a preset presentation position of the news feed list page. Since the material presentation resources generally have certain limitations, that is, are limited resources, the presentation resource occupied by the splash presentation material is associated with the presentation resource occupied by the news feed presentation material, solving the problems that the presentation duration of the material is short, and the presentation effect is not ideal due to the unachievable linkage resulting from the mutual independence and random configuration of the splash presentation material and the news feed presentation material. After the presentation of the splash presentation material is completed, the news feed presentation material corresponding to the splash presentation material is forcibly inserted into the preset presentation position of the news feed list page for presentation, so that the material presentation effect and the user experience are improved.

Based on the preceding technical solution, the news feed presentation material acquisition module 520 includes a news feed presentation material acquisition unit.

The news feed presentation material acquisition unit is configured to determine a news feed presentation identifier corresponding to the splash presentation identifier, and acquire the news feed presentation material based on the news feed presentation identifier.

Based on the preceding technical solution, the news feed presentation material acquisition unit is further configured to determine the news feed presentation identifier corresponding to the splash presentation identifier according to a preestablished corresponding relationship between the splash presentation identifier and the news feed presentation identifier.

Based on the preceding technical solution, the apparatus further involves the step described below.

In a case where a splash presentation material has the same material content as a news feed presentation material, a corresponding relationship between a splash presentation identifier of the splash presentation material and a news feed presentation identifier of the news feed presentation material is established.

Based on the preceding technical solution, the presentation module 530 is further configured to add a position identifier to the acquired news feed presentation material, and if it is detected that the news feed presentation material carries the position identifier, insert the news feed presentation material into the preset presentation position of the news feed list page.

Based on the preceding technical solution, the preset presentation position includes a top position.

Based on the preceding technical solution, the splash presentation material is stored at a different position from the news feed presentation material.

Based on the preceding technical solution, the apparatus further involves steps described below.

In a case where the news feed presentation material is scrolled out of a display region of a screen, a material presentation time when the news feed presentation material is scrolled out of the screen is recorded; and in a case where the news feed presentation material is scrolled into the display region of the screen, the material presentation time is acquired, and the news feed presentation material is continuously presented according to the material presentation time.

The multiple units and modules included in the preceding apparatus are just divided according to functional logic but are not limited to such division, as long as the corresponding functions can be implemented. Additionally, the name of each functional unit is just for distinguishing between each other but not to limit the protection scope of the embodiments of the present disclosure.

### Embodiment Six

FIG. 6 is a structural diagram of a material presentation apparatus according to embodiment six of the present disclosure. As shown in FIG. 6, the apparatus includes a splash presentation material reception module 610, a data update request sending module 620 and a news feed presentation material reception module 630.

The splash presentation material reception module 610 is configured to receive a to-be-presented splash presentation material. The data update request sending module 620 is configured to in a case where the received to-be-presented splash presentation material carries a splash presentation identifier, send a data update request carrying the splash presentation identifier to a news feed server, so as to acquire a news feed presentation material corresponding to the splash presentation identifier from the news feed server. The news feed presentation material reception module 630 is configured to receive a news feed presentation material carrying a preset presentation position of a news feed list page and issued by the news feed server, and present the news feed presentation material at the preset presentation position.

According to the technical solution of the embodiment of the present disclosure, a to-be-presented splash presentation material is received, and in a case where the received to-be-presented splash presentation material carries a splash presentation identifier, a data update request carrying the splash presentation identifier is sent to a news feed server, so as to acquire a news feed presentation material corresponding to the splash presentation identifier, that is, the news feed presentation material is determined through the splash presentation identifier, so that the linkage presentation of the splash presentation material and the news feed presentation material is achieved. Moreover, a news feed presentation material carrying a preset presentation position of a news feed list page and issued by the news feed server is received, and the news feed presentation material is presented at the preset presentation position, that is, the news feed presentation material is not randomly configured with a presentation position in the news feed list page, but inserted into the preset presentation position of the news feed list page. Since the material presentation resources generally have certain limitations, that is, are limited resources, the presentation resource occupied by the splash presentation material is associated with the presentation resource occupied by the news feed presentation material, solving the problems that the presentation duration of the material is short, and the presentation effect is not ideal due to the unachievable linkage resulting from the mutual independence and random configuration of the splash presentation material and the news feed presentation material. In this way, the material presentation effect is improved, and the technical effect of improving the user experience is achieved.

The material presentation apparatus provided by the embodiment of the present disclosure may execute the material presentation method of any embodiment of the present disclosure, and have corresponding functional modules and effects for executing the method.

The multiple units and modules included in the preceding apparatus are just divided according to functional logic but are not limited to such division, as long as the corresponding functions can be implemented. Additionally, the name of each functional unit is just for distinguishing between each other but not to limit the protection scope of the embodiments of the present disclosure.

### Embodiment Seven

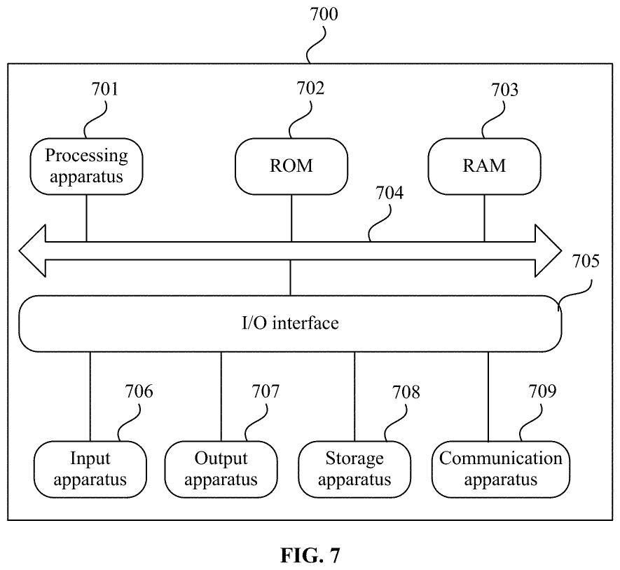

Referring to FIG. 7, FIG. 7 shows a structural diagram of an electronic device 700 (such as the terminal device or server in FIG. 7) applicable to implementing the embodiments of the present disclosure. The terminal device in the embodiments of the present disclosure may include, but is not limited to, mobile terminals such as a mobile phone, a laptop, a digital broadcast receiver, a personal digital assistant (PDA), a portable Android device (PAD), a portable media player (PMP) and a vehicle-mounted terminal (such as a vehicle-mounted navigation terminal), and fixed terminals such as a digital television (TV) and a desktop computer. The electronic device shown in FIG. 7 is merely an example and is not intended to limit the function and usage scope of the embodiments of the present disclosure.

As shown in FIG. 7, the electronic device 700 may include a processing apparatus (such as a central processing unit and a graphics processing unit) 701. The processing apparatus 701 may execute multiple appropriate actions and processing according to a program stored in a read-only memory (ROM) 702 or a program loaded into a random-access memory (RAM) 703 from a storage apparatus 708. The RAM 703 also stores various programs and data required for the operation of the electronic device 700. The processing apparatus 701, the ROM 702 and the RAM 703 are connected to each other through a bus 704. An input/output (I/O) interface 705 is also connected to the bus 704.

Generally, the following apparatuses may be connected to the I/O interface 705: an input apparatus 706 such as a touch screen, a touch pad, a keyboard, a mouse, a camera, a microphone, an accelerometer and a gyroscope; an output apparatus 707 such as a liquid crystal display (LCD), a speaker and a vibrator; the storage apparatus 708 such as a magnetic tape and a hard disk; and a communication apparatus 709. The communication apparatus 709 may allow the electronic device 700 to perform wireless or wired communication with other devices so as to exchange data. Although FIG. 7 shows the electronic device 700 having various apparatuses, not all the apparatuses shown here need to be implemented or present. Alternatively, more or fewer apparatuses may be implemented or present.

According to the embodiments of the present disclosure, the process described above with reference to the flowchart may be implemented as a computer software program. For example, the embodiments of the present disclosure include a computer program product. The computer program product includes a computer program carried in a non-transitory computer-readable medium. The computer program includes program codes for executing the method shown in the flowchart. In such an embodiment, the computer program may be downloaded from a network and installed through the communication apparatus 709, or may be installed from the storage apparatus 708, or may be installed from the ROM 702. When the computer program is executed by the processing apparatus 701, the preceding functions defined in the method of the embodiments of the present disclosure are executed.

The terminal provided in the embodiment of the present disclosure belongs to the same inventive concept as the material presentation method provided in the preceding embodiments. For the technical details not described in detail in the embodiment of the present disclosure, reference may be made to the preceding embodiments, and the embodiment of the present disclosure has the same beneficial effects as the preceding embodiments.

### Embodiment Eight

An embodiment of the present disclosure provides a computer storage medium storing a computer program thereon which, when executed by a processor, implements the material presentation method provided in the preceding embodiments.

The preceding computer-readable medium in the present disclosure may be a computer-readable signal medium or a computer-readable storage medium or any combination thereof. The computer-readable storage medium may be, but not limited to, an electrical, magnetic, optical, electromagnetic, infrared, or semiconductor system, apparatus, or device, or any combination thereof. The computer-readable storage medium may include, but not limited to, an electrical connection having one or more wires, a portable computer magnetic disk, a hard disk, a RAM, a ROM, an erasable programmable read-only memory (EPROM) or a flash memory, an optical fiber, a portable compact disc read-only memory (CD-ROM), an optical storage device, a magnetic storage device, or any suitable combination thereof. In the present disclosure, the computer-readable storage medium may be any tangible medium including or storing a program. The program may be used by or used in conjunction with an instruction execution system, apparatus, or device. In the present disclosure, the computer-readable signal medium may include a data signal propagated on a baseband or as a part of a carrier, and computer-readable program codes are carried in the data signal. The data signal propagated in this manner may be in multiple forms and includes, but is not limited to, an electromagnetic signal, an optical signal, or any suitable combination thereof. The computer-readable signal medium may further be any computer-readable medium other than the computer-readable storage medium. The computer-readable signal medium may send, propagate, or transmit a program used by or used in conjunction with an instruction execution system, apparatus, or device. The program codes included in the computer-readable medium may be transmitted in any suitable medium, including, but not limited to, a wire, an optical cable, a radio frequency (RF), or any suitable combination thereof.

In some embodiments, clients and servers may communicate using any network protocol currently known or to be developed in the future, such as the Hypertext Transfer Protocol (HTTP), and may be interconnected with digital data communication (for example, a communication network) in any form or medium. Examples of the communication network include a local area network (LAN), a wide area network (WAN), an internet (for example, the Internet), a peer-to-peer network (for example, an ad hoc network), and any network currently known or to be developed in the future.

The preceding computer-readable medium may be included in the preceding electronic device or may exist alone without being assembled into the electronic device.

The preceding computer-readable medium carries one or more programs which, when executed by the electronic device, cause the electronic device: receive a data update request from a client; in a case where the data update request carries a splash presentation identifier of a splash presentation material, acquire a news feed presentation material corresponding to the splash presentation identifier; and insert the news feed presentation material into a preset presentation position of a news feed list page.

Alternatively, the one or more programs which, when executed by the electronic device, cause the electronic device: receive a to-be-presented splash presentation material; in a case where the received to-be-presented splash presentation material carries a splash presentation identifier, send a data update request carrying the splash presentation identifier to a news feed server, so as to acquire a news feed presentation material corresponding to the splash presentation identifier from the news feed server; and receive a news feed presentation material carrying a preset presentation position of a news feed list page and issued by the news feed server.

If the child page service exists in the child scope container, for returning to the child page service. Computer program codes for performing the operations in the present disclosure may be written in one or more programming languages or combination thereof. The preceding one or more programming languages include, but are not limited to, object-oriented programming languages such as Java, Smalltalk and C++, as well as conventional procedural programming languages such as C or similar programming languages. The program codes may be executed entirely on a user computer, partly on a user computer, as a stand-alone software package, partly on a user computer and partly on a remote computer, or entirely on a remote computer or a server. In the case involving the remote computer, the remote computer may be connected to the user computer through any type of network including a LAN or a WAN, or may be connected to an external computer (for example, via the Internet through an Internet service provider).

The flowcharts and block diagrams in the drawings show possible architectures, functions and operations of the system, method and computer program product according to multiple embodiments of the present disclosure. In this regard, each block in the flowcharts or block diagrams may represent a module, a program segment, or part of codes that contains one or more executable instructions for implementing specified logical functions. In some alternative implementations, the functions marked in the blocks may occur in an order different from that marked in the drawings. For example, two successive blocks may, in fact, be executed substantially in parallel or in a reverse order, which depends on the functions involved. It is also to be noted that each block in the block diagrams and/or flowcharts and a combination of blocks in the block diagrams and/or flowcharts may be implemented by a special-purpose hardware-based system which executes specified functions or operations or a combination of special-purpose hardware and computer instructions.

The units involved in the embodiments of the present disclosure may be implemented by software or hardware. The name of a unit is not intended to limit the unit in a certain circumstance. For example, a present module may also be described as a “material presentation module”.

The functions described above herein may be executed, at least partially, by one or more hardware logic components. For example, without limitation, exemplary types of hardware logic components that may be used include: a field programmable gate array (FPGA), an application specific integrated circuit (ASIC), application specific standard parts (ASSP), a System on a Chip (SOC), a complex programmable logic device (CPLD) and the like.

In the context of the present disclosure, a machine-readable medium may be a tangible medium that may include or store a program that is used by or used in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. Examples of the machine-readable storage medium may include an electrical connection based on one or more wires, a portable computer disk, a hard disk, a RAM, a ROM, an EPROM or a flash memory, an optical fiber, a CD-ROM, an optical storage device, a magnetic storage device, or any suitable combination thereof.

In addition, although multiple operations are depicted in a particular order, this should not be construed as requiring that such operations should be performed in the particular order shown or in a sequential order. In certain circumstances, multitasking and parallel processing may be advantageous. Similarly, although implementation details are included in the preceding discussion, these should not be construed as limiting the scope of the present disclosure. Some features described in the context of separate embodiments may also be implemented in combination in a single embodiment. Conversely, various features described in the context of a single embodiment may also be implemented in multiple embodiments, individually or in any suitable sub-combination.

Although the subject matter is described in the language specific to structural features and/or methodological logic acts, it is to be understood that the subject matter defined in the present disclosure is not necessarily limited to the specific features or acts described above. Conversely, the specific features and acts described above are merely example forms of implementing the present disclosure.

What is claimed is:

1. A material presentation method, comprising:
receiving a data update request from a client;
in response to the data update request carrying a splash presentation identifier of a splash presentation material, acquiring a news feed presentation material corresponding to the splash presentation identifier; and
inserting the news feed presentation material into a preset presentation position of a news feed list page.

2. The method according to claim 1, wherein acquiring the news feed presentation material corresponding to the splash presentation identifier comprises:
determining a news feed presentation identifier corresponding to the splash presentation identifier; and
acquiring the news feed presentation material based on the news feed presentation identifier.

3. The method according to claim 2, wherein determining the news feed presentation identifier corresponding to the splash presentation identifier comprises:
determining the news feed presentation identifier corresponding to the splash presentation identifier according to a preestablished corresponding relationship between the splash presentation identifier and the news feed presentation identifier.

4. The method according to claim 3, further comprising:
in response to the splash presentation material has a same material content as the news feed presentation material, preestablishing a corresponding relationship between the splash presentation identifier of the splash presentation material and the news feed presentation identifier of the news feed presentation material.

5. The method according to claim 1, wherein inserting the news feed presentation material into the preset presentation position of the news feed list page comprises:
adding a position identifier to the acquired news feed presentation material; and
inserting the news feed presentation material added with the position identifier into the preset presentation position of the news feed list page.

6. The method according to claim 1, wherein the preset presentation position comprises a top position.

7. The method according to claim 1, wherein the splash presentation material is stored at a different position from the news feed presentation material.

8. The method according to claim 1, further comprising:
in response to the news feed presentation material being scrolled out of a display region of a screen, recording a material presentation time when the news feed presentation material is scrolled out of the screen; and
in response to the news feed presentation material being scrolled into the display region of the screen, acquiring the material presentation time, and continuously presenting the news feed presentation material on the client according to the material presentation time.

9. A material presentation method, comprising:
receiving a to-be-presented splash presentation material;
in response to the received to-be-presented splash presentation material carrying a splash presentation identifier, sending a data update request carrying the splash presentation identifier to a news feed server to acquire a news feed presentation material corresponding to the splash presentation identifier from the news feed server; and
receiving a news feed presentation material carrying a preset presentation position of a news feed list page and issued by the news feed server.

10. An electronic device, comprising:
at least one processor; and
a storage apparatus configured to store at least one program;
wherein the at least one program, when executed by the at least one processor, causes the at least one processor to implement:
receiving a data update request from a client;
in response to the data update request carrying a splash presentation identifier of a splash presentation material, acquiring a news feed presentation material corresponding to the splash presentation identifier; and
inserting the news feed presentation material into a preset presentation position of a news feed list page.

11. The electronic device according to claim 10, wherein the at least one processor acquires the news feed presentation material corresponding to the splash presentation identifier by:
determining a news feed presentation identifier corresponding to the splash presentation identifier; and
acquiring the news feed presentation material based on the news feed presentation identifier.

12. The electronic device according to claim 11, wherein the at least one processor determines the news feed presentation identifier corresponding to the splash presentation identifier by:
determining the news feed presentation identifier corresponding to the splash presentation identifier according to a preestablished corresponding relationship between the splash presentation identifier and the news feed presentation identifier.

13. The electronic device according to claim 12, wherein the at least one processor is further configured to implement:
in response to the splash presentation material has a same material content as the news feed presentation material, preestablishing a corresponding relationship between the splash presentation identifier of the splash presentation material and the news feed presentation identifier of the news feed presentation material.

14. The electronic device according to claim 10, wherein the at least one processor inserts the news feed presentation material into the preset presentation position of the news feed list page by:
adding a position identifier to the acquired news feed presentation material; and
inserting the news feed presentation material added with the position identifier into the preset presentation position of the news feed list page.

15. The electronic device according to claim 10, wherein the preset presentation position comprises a top position.

16. The electronic device according to claim 10, wherein the splash presentation material is stored at a different position from the news feed presentation material.

17. The electronic device according to claim 10, wherein the at least one processor is further configured to implement:
in response to the news feed presentation material being scrolled out of a display region of a screen, recording a material presentation time when the news feed presentation material is scrolled out of the screen; and
in response to the news feed presentation material being scrolled into the display region of the screen, acquiring the material presentation time, and continuously presenting the news feed presentation material on the client according to the material presentation time.

18. An electronic device, comprising:
at least one processor; and
a storage apparatus configured to store at least one program;
wherein the at least one program, when executed by the at least one processor, causes the at least one processor to implement the material presentation method according to claim 9.

19. A non-transitory storage medium comprising computer-executable instructions which, when executed by a computer processor, are configured to execute the material presentation method according to claim 1.

20. A non-transitory storage medium comprising computer-executable instructions which, when executed by a computer processor, are configured to execute the material presentation method according to claim 9.
